(19) United States
(12) Patent Application Publication
(10) Pub. No.: US 2026/0335821 A1
(43) Pub. Date: Oct. 29, 2026

(54) AIR PURIFIER AND OPERATING METHOD THEREOF

(71) Applicants: Seoul National University R&DB Foundation, Seoul (KR); Samsung Electronics Co., Ltd., Suwon-si (KR)

(72) Inventors: Jaiyoung Chung, Suwon-si (KR); Kyoungjae Chung, Seoul (KR); Yuyeon Kim, Seoul (KR); Sanguk Lee, Seoul (KR); Dongjin Ham, Suwon-si (KR); Dongwook Kim, Suwon-si (KR); Jinwoo Kim, Suwon-si (KR)

(21) Appl. No.: 19/651,986

(22) Filed: Apr. 20, 2026

(30) Foreign Application Priority Data
Apr. 25, 2025 (KR) 10-2025-0054799

(51) Int. Cl. B01D 53/32; B01D 53/86; B01D 53/88; H05H 1/24

(52) U.S. Cl. CPC B01D 53/32; B01D 53/8668; B01D 53/885; H05H 1/245; B01D 2257/7025; B01D 2257/708; B01D 2258/06; B01D 2259/818; H05H 2242/10; H05H 2245/20

(57) ABSTRACT

An air purifier includes a gas inlet into which polluted air is introduced, a plasma reactor connected in fluid communication with the gas inlet and having a certain discharge area which generates discharge plasma between a first electrode portion and a second electrode portion, a power supply unit which applies, between the first electrode portion and the second electrode portion, pulsed power to generate a certain voltage, and a processor which controls the power supply unit in a way such that the pulsed power has a certain pulse width.

### CROSS-REFERENCE TO RELATED APPLICATION

This application claims priority to Korean Patent Application No. 10-2025-0054799, filed on Apr. 25, 2025, and all the benefits accruing therefrom under 35 U.S.C. § 119, the content of which in its entirety is herein incorporated by reference.

### BACKGROUND

### 1. Field

The disclosure relates to an air purifier for purifying pollutants in gas and an operating method of the air purifier.

### 2. Description of the Related Art

An air purifier purifies air by decomposing pollutants in gas, for example, air. Volatile organic compounds (VOCs), as pollutants decomposed by the air purifier, are precursor substances of fine dust, and reducing VOCs may be desired for reducing fine dust.

Absorption-based removal methods utilizing activated carbon or the like may be used to reduce VOCs, but replacement of the activated carbon or other material is desired after filtering for a certain period of time. Accordingly, VOC decomposition technologies utilizing discharge plasma have been widely studied for sustainable VOC removal. Such a VOC removal method may operate at ambient atmospheric pressure at a room temperature or a low temperature and may be repeatedly used through power supply and electrode management, and thus the VOC removal method may be desired in terms of maintenance as compared to methods in the related art, which is performed replacement of an adsorbent or management of a catalyst.

### SUMMARY

Provided are, in a plasma reaction device to which pulsed power is applied, an air purifier with improved efficiency in removing pollutants, and an operating method of the air purifier.

Provided are an air purifier including a plasma-catalyst composite system in which a ceramic catalyst filter is arranged in a plasma reaction device, and an operating method of the air purifier.

Provided are an air purifier with high efficiency in which removal efficiency of pollutants is improved, and an operating method of the air purifier may be implemented.

Additional aspects will be set forth in part in the description which follows and, in part, will be apparent from the description, or may be learned by practice of the presented embodiments of the disclosure.

According to an embodiment of the disclosure, an air purifier includes a gas inlet into which polluted air is introduced, a plasma reactor connected in fluid communication with the gas inlet and having a predetermined discharge area which generates discharge plasma between a first electrode portion and a second electrode portion therein, a power supply unit which applies, between the first electrode portion and the second electrode portion, pulsed power to generate a certain voltage, and a processor which controls the power supply unit in a way such that the pulsed power has a certain pulse width of about 1 nanosecond (ns) or greater and about 160 ns or less.

In an embodiment, the processor may control the power supply unit in a way such that a voltage of about 50 kV or less is applied between the first electrode portion and the second electrode portion.

In an embodiment, the plasma reactor may include a reactor including a dielectric material and having a hollow shape extending in one direction, the first electrode portion may be arranged inside the reactor, and the second electrode portion may be arranged to be spaced apart from the first electrode portion by a certain distance.

In an embodiment, the reactor may have a cross-section of a circular or polygonal shape along one plane perpendicular to the one direction, the first electrode portion may include a high-voltage electrode to which a predetermined voltage is applied, and the second electrode portion may include a ground electrode.

In an embodiment, the plasma reactor may be provided in plurality, a plurality of plasma reactors may include a plurality of reactors, respectively, and the plurality of reactors may be stacked adjacent to each other.

In an embodiment, the air purifier may define a cooling path arranged between the plurality of reactors respectively included in the plurality of plasma reactors, and cooling water may flow along the cooling path.

In an embodiment, the plasma reactor may further include a plurality of gap spacers arranged on the first electrode portion to be spaced apart from each other by a certain distance in the one direction, the first electrode portion may be divided into a plurality of first electrode portions by the plurality of gap spacers, and each of the plurality of gap spacers may have a recessed groove shape on the first electrode portion along a plane perpendicular to the one direction.

In an embodiment, the first electrode portion and the second electrode portion may be arranged to be spaced apart from each other by a first distance along the plane perpendicular to the one direction, and the second electrode portion and the plurality of gap spacers may be arranged to be spaced apart from each other by a second distance greater than the first distance along the plane perpendicular to the one direction.

In an embodiment, the plasma reactor may further include a plurality of gap spacers arranged on the first electrode portion to be spaced apart from each other by a certain distance in the one direction, the first electrode portion may be divided into a plurality of first electrode portions by the plurality of gap spacers, the first electrode portion may further include a plurality of protrusion portions protruding from the first electrode portion along the plane perpendicular to the one direction, the plurality of gap spacers may be alternately arranged with the plurality of protrusion portions on the first electrode portion in the one direction, and each of the plurality of gap spacers may have a protruding shape on the first electrode portion along the plane perpendicular to the one direction.

In an embodiment, the plurality of protrusion portions and the second electrode portion may be arranged to be spaced apart from each other by a first distance along the plane perpendicular to the one direction, and the second electrode portion and the plurality of gap spacers may be arranged to be spaced apart from each other by a second distance greater than the first distance along the plane perpendicular to the one direction.

In an embodiment, the plasma reactor may further include a ceramic catalyst filter arranged between the reactor and the first electrode portion, the ceramic catalyst filter may include a ceramic support and a catalyst coating layer coated on the ceramic support, and the ceramic support may have a porous honeycomb structure.

In an embodiment, the reactor may have a cross-section of one or more of a circular or polygonal shape along a plane perpendicular to the one direction, and the ceramic catalyst filter may have a cross-sectional shape corresponding to a cross-sectional shape of the reactor in the discharge area.

In an embodiment, the ceramic catalyst filter may be arranged at a rear end portion of the discharge area in the one direction.

In an embodiment, t ceramic catalyst filter may be arranged to be spaced apart from the discharge area by a certain distance in the one direction.

In an embodiment, the ceramic catalyst filter may be provided in plurality, and the plurality of ceramic catalyst filters may be arranged in the discharge area to be spaced apart from each other by a certain distance in the one direction.

In an embodiment, the ceramic catalyst filter may be provided in plurality, at least one of the plurality of ceramic catalyst filters may be arranged in the discharge area to be spaced apart from each other by a certain distance in the one direction, and remaining ceramic catalyst filters among the plurality of ceramic catalyst filters may be arranged to be spaced apart from the discharge area by a certain distance in the one direction.

In an embodiment, the second electrode portion may have a plate shape extending along one plane, and the first electrode portion may extend in one direction, and may be arranged in a way such that one end portion of the first electrode portion faces the second electrode portion.

According to another embodiment of the disclosure, an operating method of the air purifier includes introducing polluted air through the gas inlet, applying pulsed power having a pulse width of about 1 ns or greater and about 160 ns or less to the first electrode portion and the second electrode portion, generating discharge plasma between the first electrode portion and the second electrode portion, passing the polluted air through the discharge area formed between the first electrode portion and the second electrode portion, and discharging purified air through a gas discharge unit of the air purifier.

In an embodiment, a voltage applied to the first electrode portion and the second electrode portion may be about 50 kV or less.

In an embodiment, the method may further include passing the polluted air through the ceramic catalyst filter arranged between a reactor of the plasma reactor and the first electrode portion.

### BRIEF DESCRIPTION OF THE DRAWINGS

The above and other features of certain embodiments of the disclosure will be more apparent from the following description taken in conjunction with the accompanying drawings, in which:

FIG. 1 is a schematic configuration diagram of an air purifier according to an embodiment;

FIG. 2 is a graph showing a change in voltage over time of pulsed power applied from a power supply unit according to an embodiment;

FIG. 3A is a schematic diagram of an air purifying system including a dielectric barrier discharge plasma reactor according to an embodiment;

FIG. 3B is a schematic diagram of a dielectric barrier discharge plasma reactor according to an embodiment;

FIG. 4A is a perspective view of a first electrode portion according to an embodiment;

FIG. 4B is a schematic cross-sectional view of a plasma reactor according to an embodiment;

FIG. 5 is a graph showing the removal rate of pollutants and removal efficiency of pollutants according to an operating time of an air purifier according to an embodiment;

FIG. 6 is a graph showing the removal efficiency of pollutants with respect to a voltage applied to a plasma reactor by a power supply unit according to an embodiment;

FIG. 7A is a schematic diagram of a dielectric barrier discharge plasma reactor according to an embodiment;

FIG. 7B is a schematic cross-sectional view of a plasma reactor according to an embodiment;

FIG. 8A is a schematic diagram of a plasma reactor in which a ceramic catalyst filter is arranged, according to an embodiment;

FIG. 8B is a front view of a plasma reactor in which a ceramic catalyst filter is arranged, according to an embodiment;

FIG. 8C is a partially enlarged view of the catalyst filter, showing region N illustrated in FIG. 8B;

FIG. 9 is a schematic diagram of a dielectric barrier discharge plasma reactor according to an embodiment;

FIG. 10A is a schematic diagram of a dielectric barrier discharge plasma reactor according to an embodiment;

FIG. 10B is a schematic diagram of a dielectric barrier discharge plasma reactor according to an embodiment;

FIG. 11 is a schematic diagram of a corona discharge plasma reactor according to an embodiment;

FIG. 12A is a perspective view of a plurality of reactors according to an embodiment;

FIG. 12B is a cross-sectional view of a plurality of plasma reactors according to an embodiment;

FIG. 12C is a front view of a plasma reactor in which a ceramic catalyst filter is arranged, according to an embodiment;

FIG. 13A is a perspective view of a plurality of reactors according to an embodiment;

FIG. 13B is a cross-sectional view of a plurality of plasma reactors according to an embodiment;

FIG. 13C is a front view of a plasma reactor in which a ceramic catalyst filter is arranged, according to an embodiment; and

FIG. 14 is a flowchart illustrating an operating method of an air purifier according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. In addition, it will also be understood that terms, such as terms defined in commonly used dictionaries, should be interpreted to have a meaning consistent with their meaning in the context of the relevant art and the disclosure, and not as idealized, and will not be interpreted in an idealized or overly formal sense unless expressly so defined herein.

Embodiments are described herein with reference to schematic cross-sectional views of ideal embodiments. As such, variations from the shape of the illustration as a result of, for example, manufacturing techniques and/or tolerances should be expected. Accordingly, the embodiments described herein should not be construed as limited to the specific shapes of the regions illustrated herein, but should include deviations in shapes resulting from, for example, manufacturing. For example, regions described or depicted as flat may typically have rough and/or non-linear features. In addition, the sharp angles illustrated may be rounded. Accordingly, regions depicted in the drawings are schematic in nature, and their shapes are not intended to illustrate the precise shape of the regions and are not intended to limit the scope of the claims.

Hereinafter, embodiments of an air purifier and an operating method of the air purifier will be described in greater details with reference to the accompanying drawings.

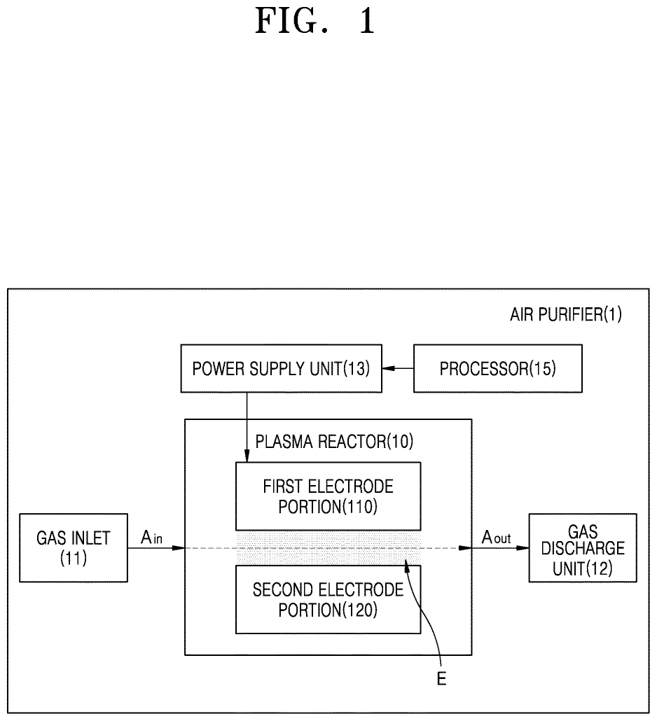

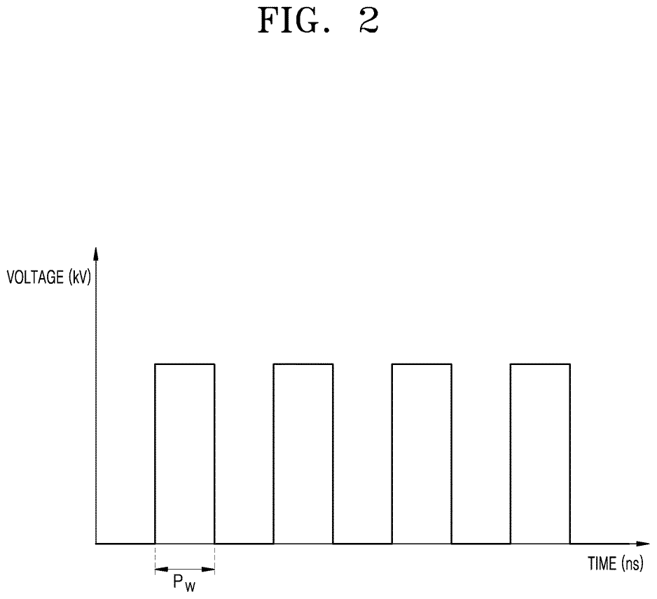

FIG. 1 is a schematic configuration diagram of an air purifier according to an embodiment. FIG. 2 is a graph showing a change in voltage over time of pulsed power applied from a power supply unit according to an embodiment.

Referring to FIGS. 1 and 2, an air purifier 1 according to an embodiment may include a plasma reactor 10 that purifies polluted air by using discharge plasma, a gas inlet 11 configured to introduce polluted air Aᵢₙ into the plasma reactor 10, a gas discharge unit 12 connected to the plasma reactor 10 to be in fluid communication and which discharges purified air Aₒᵤₜ discharged from the plasma reactor 10, a power supply unit 13 that applies pulsed power supply to the plasma reactor 10, and a processor 15.

In the specification, the air purifier 1 including the plasma reactor 10 except a dust collector is described, but the disclosure is not limited thereto. In an embodiment, for example, the air purifier 1 may also include a dust collector (not shown) capable of collecting pollutants and discharging the collected pollutants to the outside, in addition to the plasma reactor 10. The dust collector (not shown) may be sequentially arranged in a flow direction of the polluted air Aᵢₙ. Accordingly, the purified air Aₒᵤₜ discharged from the plasma reactor 10 may be introduced into the dust collector (not shown) in a state of being charged by discharge plasma to be collected.

Herein, the polluted air Aᵢₙ means a mixed gas including air and at least one selected from particle matter (PM), a water-soluble organic compound (VOCₛₒₗ), and a water-insoluble organic compound (VOCᵢₙₛₒₗ). As an example, the PM may include a fine PM of about 10 μmor less and an ultrafine PM of about 0.3 μm or less. In addition, the VOCₛₒₗ is a volatile organic compound, which may include gaseous substances that may be captured and removed by water or aqueous solutions, for example, ammonia (NH₃), acetaldehyde (CH₃CHO), and acetic acid (CH₃COOH). In addition, the VOCᵢₙₛₒₗ is a volatile organic compound that is not captured by water or aqueous solutions, which may include, for example, benzene (C₆H₆), formaldehyde (CH₂O), toluene (C₆H₅CH₃), etc. However, the disclosure is not limited thereto, any other gases may be included in the polluted air Aᵢₙ, in addition to the PM, the VOCₛₒₗ, and the VOCᵢₙₛₒₗ.

The plasma reactor 10 according to an embodiment may be connected to the gas inlet 11 to be in fluid communication and may purify the polluted air Aᵢₙ introduced from the gas inlet 11. In an embodiment, for example, the plasma reactor 10 may include a first electrode portion 110 and a second electrode portion 120, which are arranged to be spaced apart from each other by a certain distance. A certain discharge area E that generates plasma may be formed between the first electrode portion 110 and the second electrode portion 120. In an embodiment, for example, the power supply unit 13 may apply power that generates a certain voltage to the first electrode portion 110 and the second electrode portion 120. At this time, discharge plasma may be generated in the discharge area E provided between the first electrode portion 110 and the second electrode portion 120. The polluted air Aᵢₙ introduced to the plasma reactor 10 may be decomposed by the discharge plasma formed in the discharge area E.

In an embodiment, for example, the VOCᵢₙₛₒₗ may be directly decomposed by using the plasma reactor 10. According to an embodiment, when a high voltage is applied to the discharge area E, the VOCₛₒₗ may be decomposed by using OH radicals (OH·). In an embodiment, for example, when a high voltage is applied to the discharge area E, oxygen (O₂) and water molecules (H₂O) in the air around the first electrode portion 110 may break down and become a state of neutral gas ions (plasma state), and the OH· may be generated from these ions. In an embodiment, for example, CH₃COOH, CH₃CHO, and CH₄ among VOCₛₒₗ may be decomposed into carbon dioxide (CO₂) and water (H₂O), as shown in reaction formulas 1 to 3. At this time, a decomposition product, that is, the purified air Aₒᵤₜ, for example, CO₂ and H₂O, may be discharged to the outside through the gas discharge unit 12.

CH₃COOH+4OH+O₂→2CO₂+4H₂O [Reaction Formula 1]

CH₃CHO+6OH+O₂→2CO₂+5H₂O [Reaction Formula 2]

CH₄+4OH+O₂→CO₂+4H₂O [Reaction Formula 3]

In an embodiment, for example, the VOCᵢₙₛₒₗ may be directly decomposed by using the plasma reactor 10. According to an embodiment, when a high voltage is applied to the discharge area E, the VOCᵢₙₛₒₗ may be decomposed by using OH·. In an embodiment, for example, when a high voltage is applied to the discharge area E, O₂ and H₂O in the air around the first electrode portion 110 may break down and become a state of neutral gas ions (plasma state), and the OH·may be generated from these ions. In an embodiment, for example, water-soluble organic C₆H₅CH₃ may be decomposed into CO₂ and water H₂O by OH·. At this time, a decomposition product, that is, the purified air Aₒᵤₜ, for example, CO₂ and H₂O, may be discharged to the outside through the gas discharge unit 12.

In an embodiment, for example, ozone (O₃) may be generated from O₂ in the air by the plasma reactor 10. When O₃ is generated within the plasma reactor 10, the O₃ may be coupled to fine droplets and used as ozone water. However, when the concentration of O₃ generated by the plasma reactor 10 exceeds the range that may be used as ozone water, excess O₃ may be removed by arranging an ozone decomposition catalyst filter (not shown) at the rear end of the plasma reactor 10.

In an embodiment, as described above, VOCₛₒₗ and VOCᵢₙₛₒₗ included in the polluted air Aᵢₙ passing through the plasma reactor 10 may be removed by using a decomposition method using the plasma reactor 10. In addition, PM included in the polluted air Aᵢₙ passing through the plasma reactor 10 may be charged by discharge plasma. Accordingly, some pollutants may be removed by the plasma reactor 10, and the purified air Aₒᵤₜ including the charged PM may be discharged from the plasma reactor 10.

According to an embodiment, the plasma reactor 10 included in the air purifier 1 may continuously generate low-temperature plasma at low voltage. In an embodiment, for example, polluted air Aᵢₙ may be continuously introduced through the gas inlet 11. At this time, to continuously remove the pollutants included in the polluted air Aᵢₙ, the plasma reactor 10 must continuously generate low-temperature plasma at low voltage.

The power supply unit 13 according to an embodiment may apply pulsed power so that low-temperature plasma may be continuously generated between the first electrode portion 110 and the second electrode portion 120, which are provided in the plasma reactor 10. In an embodiment, for example, the power supply unit 13 may include a direct current (DC) power supply device and a transformer. The power supply unit 13 may continuously apply a high voltage to the inside of the plasma reactor 10, for example, the discharge area E where discharge plasma may be generated, through the above-described electric system. In an embodiment, for example, a voltage applied to the discharge area E may be 1 about kilovolt (kV) or greater and about 50 kV or less, and a frequency may be about 1 kHz or greater and about 100 kHz or less, but the disclosure is not limited thereto. In an embodiment, a separation distance between the first electrode portion 110 and the second electrode portion 120 in the discharge area E may be about 4 millimeters (mm) or greater and about 150 mm or less, and accordingly, an electric field of about 1 kilovolt per centimeter (kV/cm) or greater and about 15 kV/cm or less may be applied to the discharge area E.

The power supply unit 13 according to an embodiment may apply pulsed power as shown in FIG. 2 to the inside of the plasma reactor 10, for example, the first electrode portion 110 and the second electrode portion 120 where discharge plasma may be generated. In an embodiment, for example, pulsed power applied by the power supply unit 13 may have a pulse width P_{w} of about 1 nanosecond (ns) or greater and about 160 ns or less. As the power applied by the power supply unit 13 has certain pulsed power, low-temperature plasma may be continuously generated between the first electrode portion 110 and the second electrode portion 120, which are provided in the plasma reactor 10, and energy efficiency may be improved.

According to an embodiment, the plasma reactor 10 to which pulsed power is applied may operate based on one or more discharge methods from among a dielectric barrier discharge method and a corona discharge method. However, the disclosure is not limited thereto, and the air purifier 1 according to an embodiment may also include the plasma reactor 10 to which any pulsed power is applied. Hereinafter, embodiments of the air purifier 1 including the plasma reactor 10 to which a dielectric barrier discharge method is applied will be mainly described.

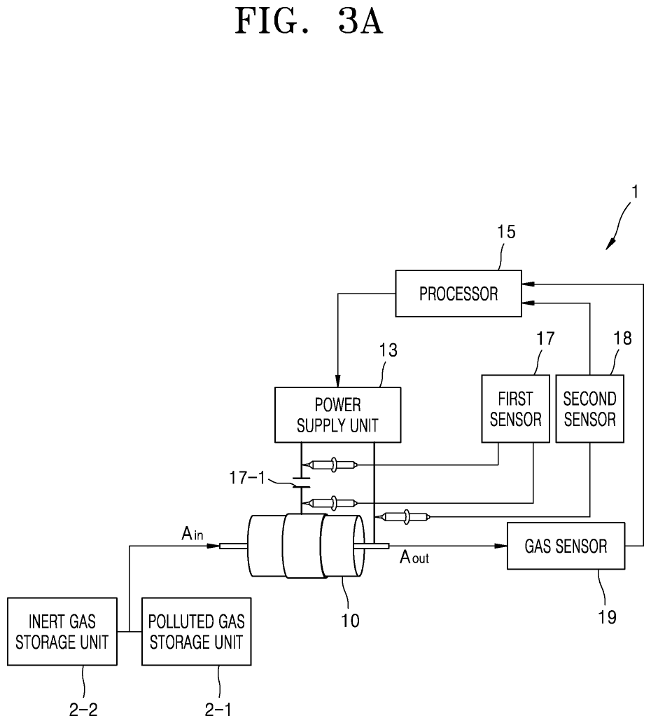

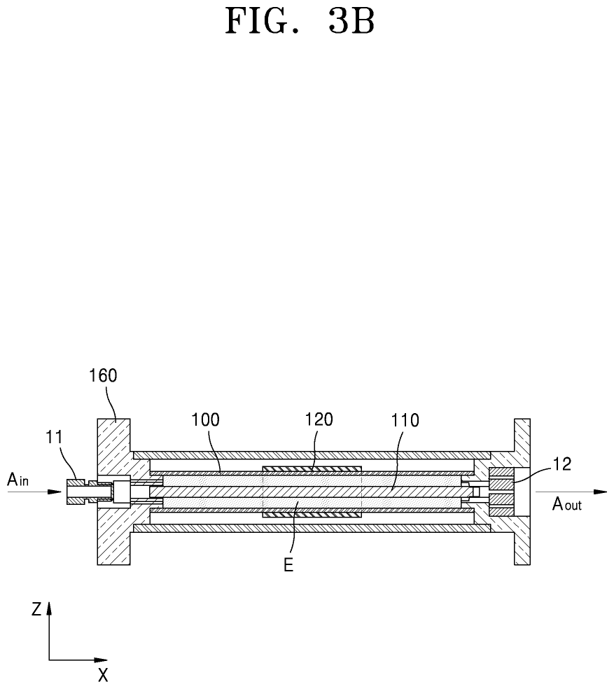

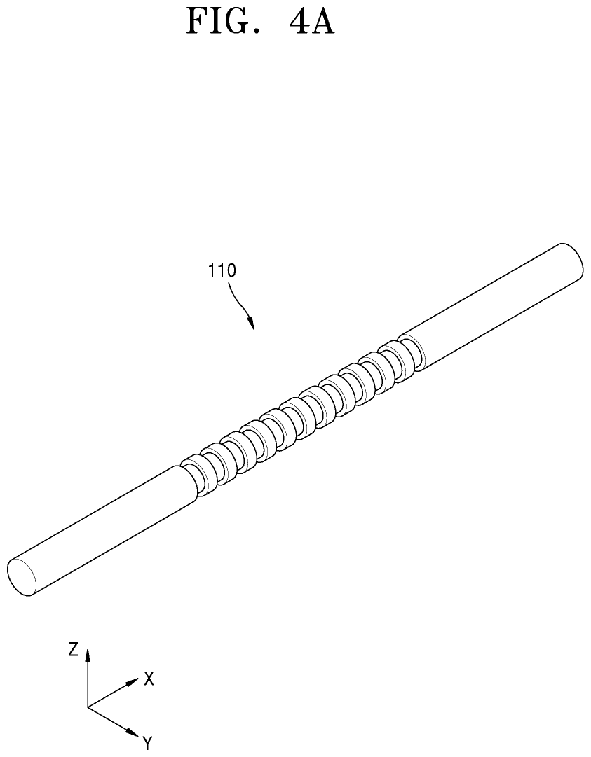

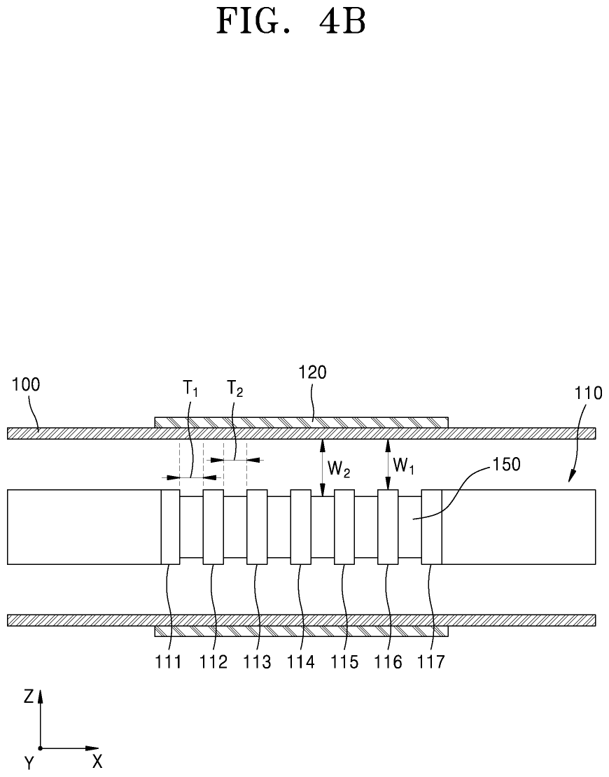

FIG. 3A is a schematic diagram of an air purifying system including a dielectric barrier discharge plasma reactor according to an embodiment. FIG. 3B is a schematic diagram of a dielectric barrier discharge plasma reactor according to an embodiment. FIG. 4A is a perspective view of a first electrode portion according to an embodiment. FIG. 4B is a schematic cross-sectional view of a plasma reactor according to an embodiment.

Referring to FIGS. 3A and 3B, the air purifier 1 according to an embodiment may include a plasma reactor 10 to which a dielectric barrier discharge method is applied, the power supply unit 13, and the processor 15. In addition, as shown in FIG. 3B, the gas inlet 11 and the gas discharge unit 12 may be provided in the plasma reactor 10, polluted air Aᵢₙ including pollutants may be introduced into the plasma reactor 10 through the gas inlet 11, and purified air Aₒᵤₜ after a reaction may be discharged from the plasma reactor 10 through the gas discharge unit 12. According to an embodiment, the polluted air Aᵢₙ introduced through the gas inlet 11 may include pollutants, for example, volatile organic compounds (VOC), introduced from a polluted gas storage unit 2-1, and may additionally include inert gas introduced from an inert gas storage unit 2-2 to facilitate plasma generation. The inert gas may include, for example, helium, nitrogen, argon, or a combination thereof.

The plasma reactor 10 according to an embodiment may include a reactor 100, which is hollow, extending in one direction, the first electrode portion 110 arranged inside the reactor 100, a second electrode portion 120 arranged to be spaced apart from the first electrode portion 110 by a certain distance, a power supply unit 13 that applies, between the first electrode portion 110 and the second electrode portion 120, pulsed power having a certain voltage, and the processor 15 that controls power generated from the power supply unit 13.

The reactor 100 may extend in one direction and may have a hollow shape through which the polluted air Aᵢₙ may move. In an embodiment, for example, the reactor 100 may include a dielectric material. In an embodiment, for example, the reactor 100 may be a glass tube including quartz and extending in one direction, but the disclosure is not limited thereto. In an embodiment, for example, the reactor 100 may be provided as a hollow tube including any dielectric material.

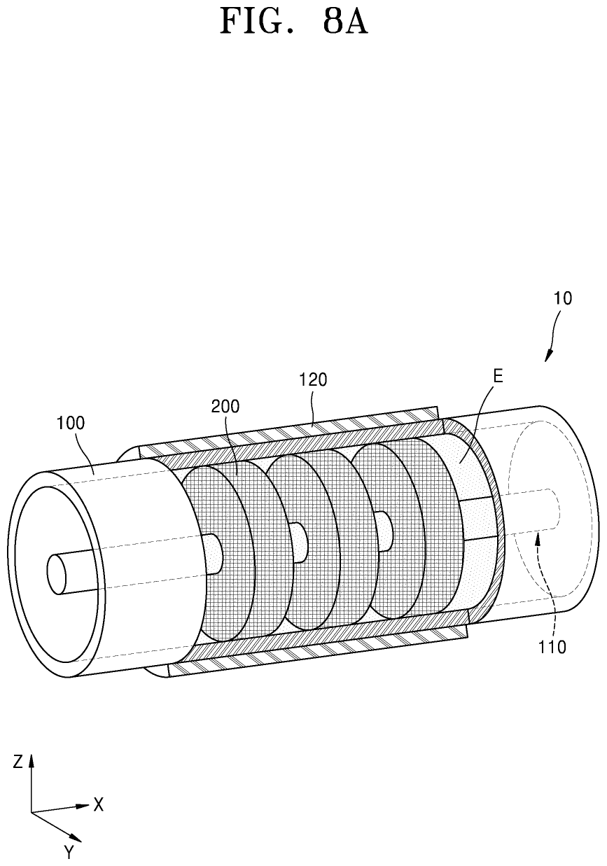

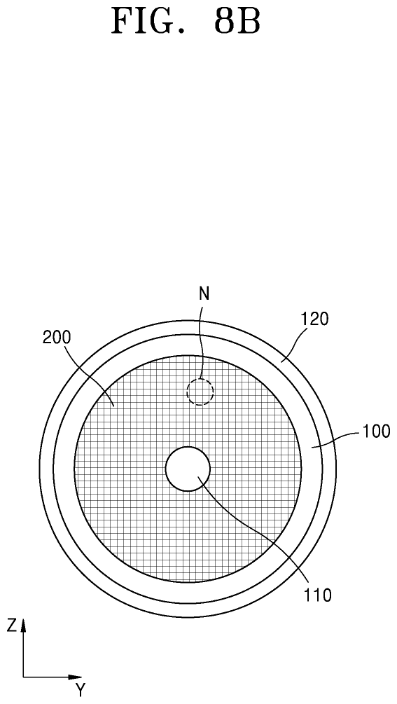

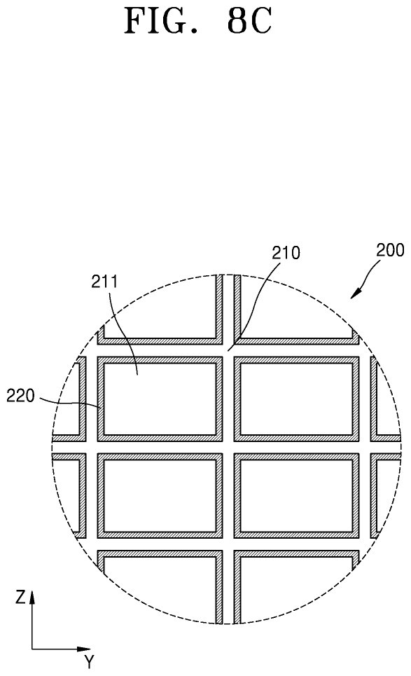

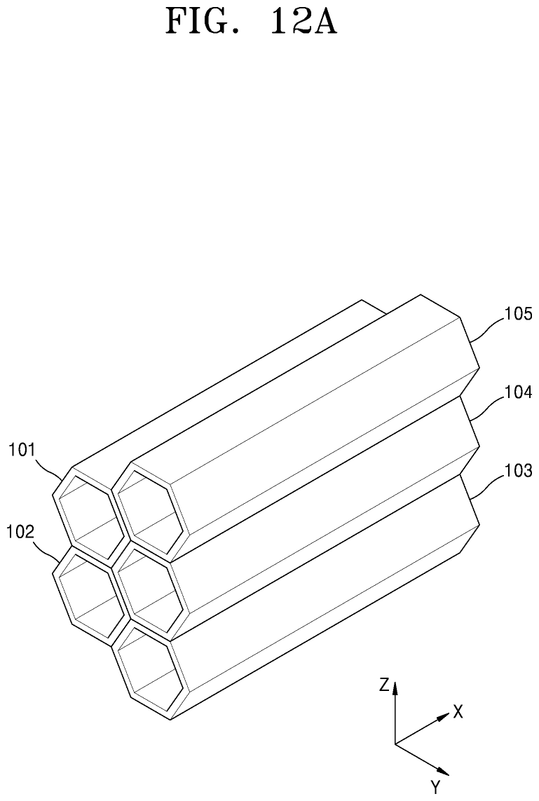

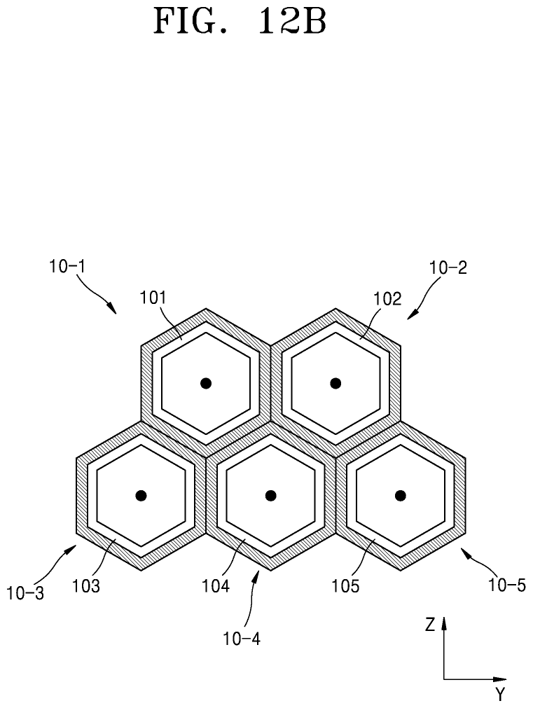

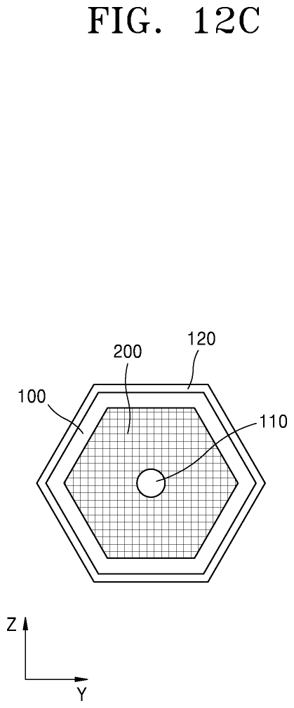

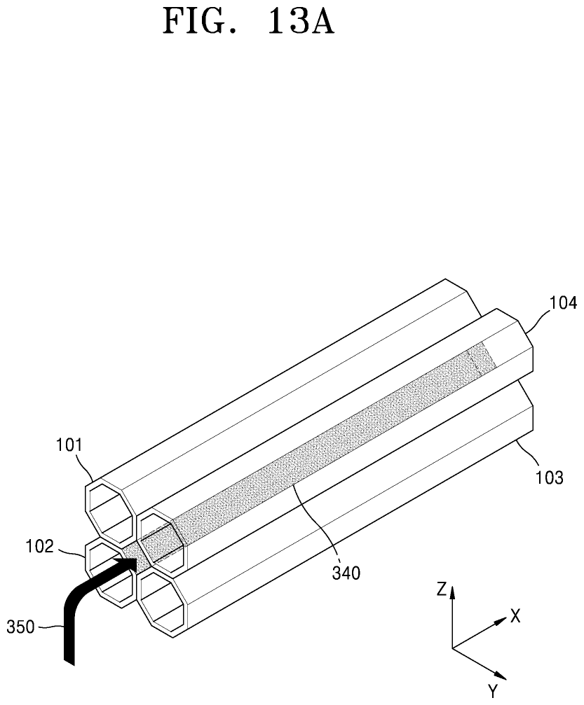

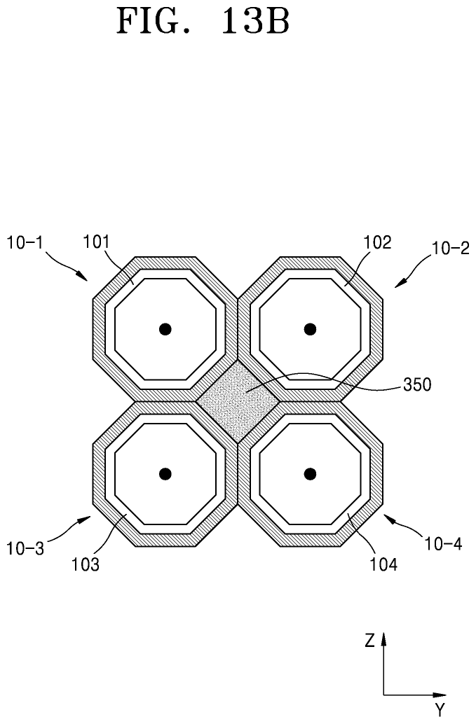

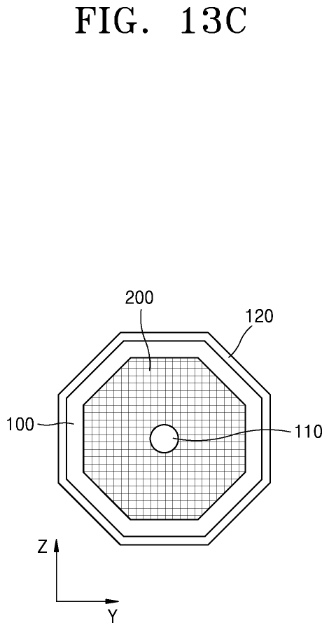

The reactor 100 according to an embodiment may be provided as a hollow tube having a cross-section of a circular or polygonal shape. In an embodiment, for example, as shown in FIG. 8A, the reactor 100 may be provided in a circular tube shape including a circular cross-section. In another embodiment, for example, as shown in FIG. 12C, the reactor 100 may be provided in a tube shape including a hexagonal cross-section. In another embodiment, for example, as shown in FIG. 13C, the reactor 100 may be provided in a tube shape including an octagonal cross-section.

According to an embodiment, as the reactor 100 includes a cross-section of a circular or polygonal shape, a plurality of reactors 100 may be integrated and arranged to be adjacent to each other. Accordingly, the cross-sectional area of the reactor 100 through which the polluted air Aᵢₙ passes may be increased, and the size of the entire air purifier 1 may be reduced. Details related to integrating and arranging the plurality of reactors 100 to be adjacent to each other will be described below with reference to FIGS. 12A to 13C.

The first electrode portion 110 may extend in one direction and may be arranged inside the reactor 100. According to an embodiment, the first electrode portion 110 may be connected to the power supply unit 13 as a power electrode. In an embodiment, for example, the first electrode portion 110 may be provided as a stainless steel wire extending in one direction to be arranged inside the reactor 100. However, the disclosure is not limited thereto, and the first electrode portion 110 may be provided in the form of any electrode structure extending in one direction.

The second electrode portion 120 may be arranged to be spaced apart from the first electrode portion 110 by a certain distance. According to an embodiment, the discharge area E where discharge plasma may be generated may be formed between the first electrode portion 110 and the second electrode portion 120. In an embodiment, for example, the second electrode portion 120 may be a ground electrode arranged on the outer peripheral surface of the reactor 100. In such an embodiment, the discharge area E where discharge plasma may be generated may be surrounded by the second electrode portion 120. In an embodiment, for example, where the reactor 100 has a hollow tube shape including a dielectric material, the second electrode portion 120 may be provided as a conductive film, for example, a silver paste film, to be arranged to surround the outer wall of the reactor 100.

As described above, the discharge area E where discharge plasma may be generated may be defined as an area surrounded by the second electrode portion 120. Accordingly, in a case where the first electrode portion 110 extends on the discharge area E in one direction (X direction), discharge plasma may be generated throughout the discharge area E in the one direction (X direction). In this case, it may be difficult to generate uniform plasma throughout the discharge area E in the one direction (X direction).

According to an embodiment, a plurality of gap spacers 150 may be arranged on the first electrode portion 110 to be spaced apart from each other by a certain distance. In an embodiment, for example, as shown in FIGS. 4A and 4B, the first electrode portion 110 may be divided into a plurality of first electrode portions 110 by the plurality of gap spacers 150 by arranging the plurality of gap spacers 150 on the first electrode portion 110. The first electrode portion 110, which is divided into the plurality of first electrode portions 110, may include a first first electrode portion (hereinafter, will be referred to as “first-1 electrode portion”) 111 to a seventh first electrode portion (hereinafter, will be referred to as “first-7 electrode portion”) 117. The plurality of gap spacers 150 may be respectively arranged between the first-1 electrode portion 111 to the first-7 electrode portion 117. In an embodiment, for example, gap spacers 150 may be arranged between the first-1 electrode portion 111 and a second first electrode portion (hereinafter, will be referred to as “first-2 electrode portion”) 112 and between the first-2 electrode portion 112 and a third first electrode portion (hereinafter, will be referred to as “first-3 electrode portion”) 113, respectively.

According to an embodiment, the plurality of first electrode portions 110, which are divided by the plurality of gap spacers 150, may be arranged to be spaced apart from each other by a certain distance. In an embodiment, for example, a first separation T₁ distance between the first-1 electrode portion 111 and the first-2 electrode portion 112 may be equal to a second separation distance T₂ between the first-2 electrode portion 112 and the first-3 electrode portion 113.

In another embodiment, for example, the plurality of gap spacers 150 may be provided on the first electrode portion 110 in recessed groove shapes along one plane (YZ plane) perpendicular to the one direction (X direction). In an embodiment, for example, when the first electrode portion 110 and the second electrode portion 120 are arranged to be spaced apart from each other by a first distance W₁ along the one plane (YZ plane) perpendicular to the one direction (X direction), the second electrode portion 120 and the plurality of gap spacers 150 may be arranged to be spaced apart from each other by a second distance W₂ along the one plane (YZ plane) perpendicular to the one direction (X direction). According to an embodiment, the first electrode portion 110 and the plurality of gap spacers 150 may include a same material as each other and may also be integrally formed. However, the disclosure is not limited thereto, and the first electrode portion 110 and the plurality of gap spacers 150 may also include different materials and may be formed in a way of being prepared separately and then coupled to each other.

In an embodiment, as described above, as the separation distance of the first electrode portion 110, which is divided into the plurality of first electrode portions 110, and the separation distance between the plurality of first electrode portions 110 and the second electrode portion 120 are accurately fixed by the plurality of gap spacers 150, uniform plasma may be generated throughout the entire discharge area E provided between the plurality of first electrode portions 110 and the second electrode portion 120. In such an embodiment, as the separation distance of the first electrode portion 110, which is divided into the plurality of first electrode portions 110, and the separation distance between the plurality of first electrode portions 110 and the second electrode portion 120 are accurately fixed by the plurality of gap spacers 150, reproducibility of implementing the same discharge plasma in a same process may be secured.

Referring to back FIGS. 2, 3A, and 3B, according to an embodiment, when pulsed power having a certain voltage is applied between the first electrode portion 110 and the second electrode portion 120 from the power supply unit 13, a removal rate (V) of pollutants included in the polluted air Aᵢₙ may vary depending on the pulse width P_{w} of the pulsed power. In an embodiment, for example, when the pulse width P_{w} of pulsed power is increased, the removal rate (V) of pollutants included in the polluted air Aᵢₙ may be improved. However, when the pulse width P_{w} of pulsed power is increased, the amount of power used by the power supply unit 13 may increase, and thus energy efficiency may decrease. Accordingly, the removal rate (V) of pollutants included in the polluted air Aᵢₙ may be inversely proportional to the amount of power used by the power supply unit 13.

According to an embodiment, the processor 15 may determine and control the pulse width P_{w} of pulsed power applied from the power supply unit 13 by considering a ratio of the amount of power used by the power supply unit 13 to the removal rate (V) of pollutants included in the polluted air Aᵢₙ. Hereinafter, the ratio of the amount of power used by the power supply unit 13 to the removal rate (V) of pollutants included in the polluted air Aᵢₙ is referred to as removal efficiency (K) of pollutants.

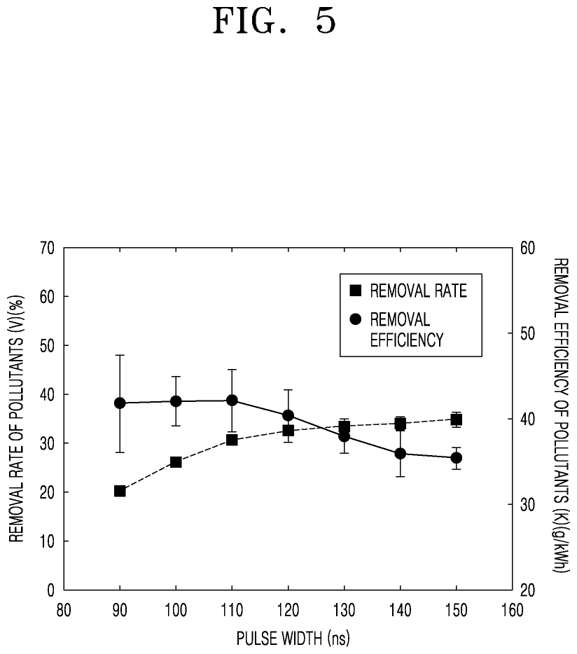

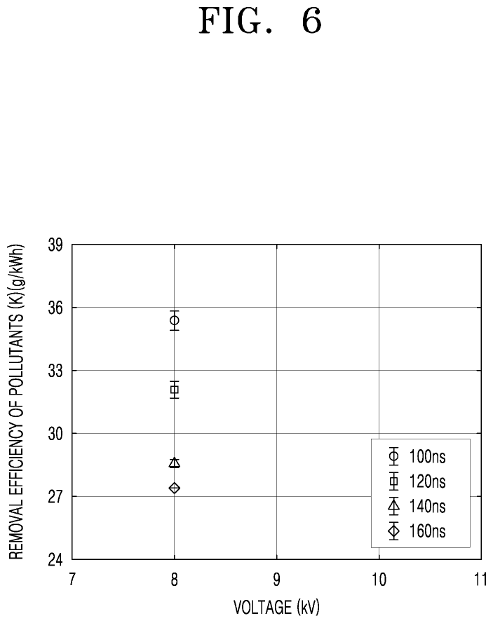

FIG. 5 is a graph showing the removal rate of pollutants and removal efficiency of pollutants according to an operating time of an air purifier according to an embodiment. FIG. 6 is a graph showing the removal efficiency of pollutants with respect to a voltage applied to a plasma reactor by a power supply unit according to an embodiment.

Referring to FIGS. 3A to 4B and the following embodiment, the removal efficiency (K) of pollutants in the air purifier 1 according to an embodiment will be described in more detail. However, the embodiment is intended to illustrate the technical idea and is not intended to limit the scope of the disclosure.

### Embodiment

In an embodiment, the reactor 100 has a hollow tube shape with a length of 220 mm, an outer diameter of 26 mm, and a thickness of 3 mm, and includes quartz as a dielectric material. The first electrode portion 110 is a stainless steel wire having a length of 200 mm in one direction (X direction) and a diameter of 8 mm, and is arranged inside the reactor 100. In such an embodiment, gap spacers 150 having groove shapes are arranged at intervals of 3 mm. The second electrode portion 120 is a silver paste tube arranged on the outer peripheral surface of the reactor 100 to have a length of 60 mm in the one direction (X direction). In such an embodiment, the separation distance between the first electrode portion 110 and the second electrode portion 120, that is, a discharge distance, is 6 mm.

Pollutants supplied from the polluted gas storage unit 2-1 is C₆H₅CH₃ gas, which is supplied at a flow rate of 0.3 liter per minute (L/min), and an inert gas supplied from the inert gas storage unit 2-2 is helium gas, which is supplied at a flow rate of 1.7 liters per minute (L/min). Accordingly, the polluted air Aᵢₙ is introduced to the plasma reactor 10 at a flow rate of 2.0 L/min. At this time, the dilution ratio of the pollutants, that is, toluene, may be 1/1000, and the initial concentration of toluene may be about 150 mm.

The polluted air Aᵢₙ introduced to the plasma reactor 10 is discharged as purified air Aₒᵤₜ with pollutants removed by the plasma reactor 10. A gas sensor 19 detects the concentration of pollutants included in the purified air Aₒᵤₜ. In an embodiment, for example, the gas sensor 19 may be a photothermal induced resonance infrared (PT-IR) spectrometer, but the disclosure is not limited thereto. The processor 15 may calculate the removal efficiency (K) (%) of pollutants through the concentration of pollutants included in the purified air Aₒᵤₜ, which is detected by the gas sensor 19. In an embodiment where the pollutants include toluene, the removal amount of pollutants may be calculated using the following formula.

toluene removal amount (L)=toluene introduction flow rate (L/min)×treatment time (min)×removal efficiency (K) of pollutants/100 [Formula 1]

toluene removal amount (g)=toluene removal amount (L)/22.4 (L/mol)×92.4 (g/mol) [Formula 2]

Energy used in a process of removing the polluted air Aᵢₙ in the plasma reactor 10 is detected by a first sensor 17 and a second sensor 18. The first sensor 17 detects a charge (Q) used in the process of removing the polluted air Aᵢₙ in the plasma reactor 10 by using a monitor capacitor 17-1 connected to the second electrode portion 120. The second sensor 18 is connected to the first electrode portion 110 to detect a voltage V applied in the process of removing the polluted air Aᵢₙ in the plasma reactor 10.

The processor 15 calculates energy per pulse J using the following formula.

Energy per pulse (J)=∫Q dV [Formula 3]

Energy used in the process of removing the polluted air Aᵢₙ in the plasma reactor 10 may be calculated using the following formula.

total applied energy (J)=energy per pulse (J) ×pulse repetition rate (kHz) ×processing time(s) [Formula 4]

total applied energy (kWh)=total applied energy (J)/3,600,000 (J/kWh) [Formula 5]

Accordingly, the removal efficiency (K) of pollutants (g/kWh) may be determined as follows by using the removal amount of toluene (g) checked in formula 2 and the total applied energy (kWh) checked in formula 5.

Removal Efficiency (k) of Pollutants (g/kwh)=Removal Amount of Toluene (g)/total applied energy (kWh) [Formula 6]

In an embodiment, the removal rate (V) of pollutants (%) and the removal efficiency (K) of pollutants (g/kWh) are measured by changing the pulse width Pw of pulsed power applied by the power supply unit 13. At this time, the voltage of pulsed power applied by the power supply unit 13 is 8 kV.

Referring to FIG. 5, it is shown that the removal rate (V) of pollutants (%) may increase as the pulse width Pw of pulsed power applied by the power supply unit 13 increases. However, it is shown that an increased width of the removal rate (V) of pollutants (%) decreases as an absolute value of the pulse width Pw increases. That is, even when the pulse width Pw of pulsed power increases, the removal efficiency (K) of pollutants (g/kWh) may decrease.

Referring to FIG. 6, it is shown that, when the pulse width Pw of pulsed power applied by the power supply unit 13 is about 160 ns or less, the removal efficiency (K) of pollutants (g/kWh) of actual significance, for example, the removal efficiency (K) of pollutants (g/kWh) of about 27 (g/kWh) or greater, may be secured. Accordingly, the processor 15 according to an embodiment may control the power supply unit 13 so that the power supply unit 13 applies, between the first electrode portion 110 and the second electrode portion 120, pulsed power having the pulse width Pw of about 1 ns or greater and about 160 ns or less. However, the disclosure is not limited thereto, and the processor 15 may control the power supply unit 13 to apply, between the first electrode portion 110 and the second electrode portion 120, pulsed power having the pulse width Pw of about 1 ns or greater and about 200 ns or less.

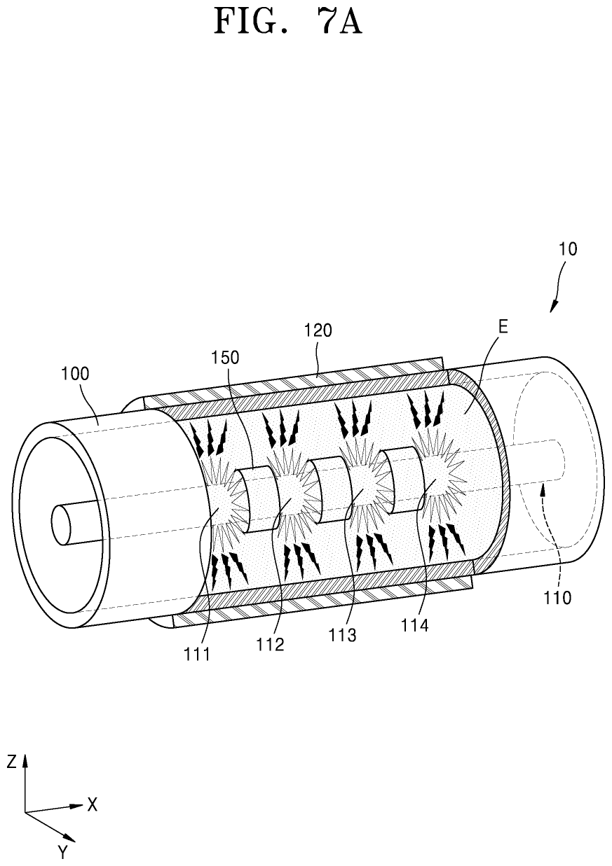

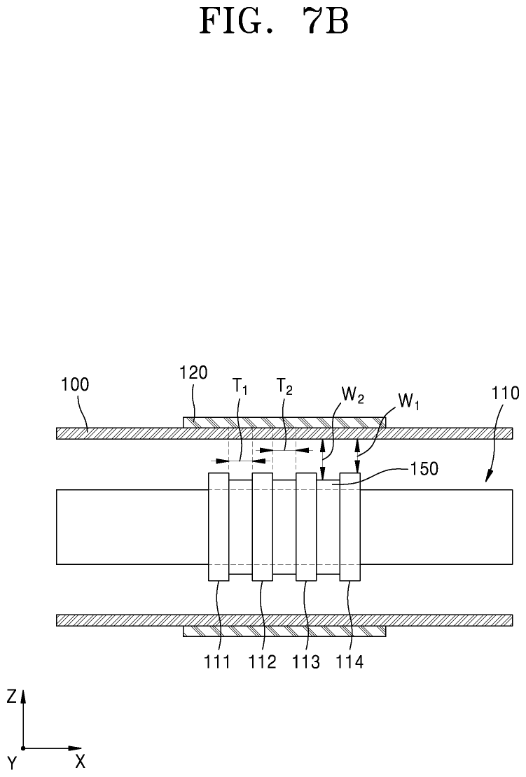

FIG. 7A is a schematic diagram of a dielectric barrier discharge plasma reactor according to an embodiment. FIG. 7B is a schematic cross-sectional view of a plasma reactor according to an embodiment.

Referring to FIGS. 7A and 7B, the discharge area E where discharge plasma may be generated may be defined as an area surrounded by the second electrode portion 120. Accordingly, in a case where the first electrode portion 110 extends on the discharge area E in one direction (X direction), discharge plasma may be generated throughout the discharge area E in the one direction (X direction). In this case, it may be difficult to generate uniform plasma throughout the discharge area E in the one direction (X direction).

According to an embodiment, the first electrode portion 110 may further include, along one plane (YZ plane) perpendicular to the one direction (X direction), a plurality of protrusion portions 111 to 114 protruding from the outer peripheral surface of the first electrode portion 110. In an embodiment, for example, the plurality of protrusion portions 111 to 114 may be formed to protrude from the outer peripheral surface of the first electrode portion 110, or may be provided in a ring shape with a hollow space and arranged to be inserted into the first electrode portion 110. In the disclosure, the plurality of protrusion portions 111 to 114 are depicted as four protrusion portions, but the disclosure is not limited thereto, and the plurality of protrusion portions 111 to 114 may be formed in any number of 2 or greater.

The plurality of gap spacers 150 may be alternately arranged with the plurality of protrusion portions 111 to 114 on the first electrode portion 110 in the one direction (X direction). The plurality of protrusion portions 111 to 114 may be divided into multiple numbers by the plurality of gap spacers 150 by alternately arranging the plurality of protrusion portions 111 to 114 and the plurality of gap spacers 150. In an embodiment, for example, the plurality of gap spacers 150 may be arranged between a first protrusion portion 111 to a fourth protrusion portion 114, respectively. In an embodiment, for example, gap spacers 150 may be arranged between the first protrusion portion 111 and the second protrusion portion 112 and between the second protrusion portion 112 and a third protrusion portion 113, respectively.

According to an embodiment, the first to fourth protrusion portions 111 to 114, which are divided into multiple numbers by the plurality of gap spacers 150, may be arranged to be spaced apart from each other by a certain distance. In an embodiment, for example, a first separation distance T₁ between the first protrusion portion 111 and the second protrusion portion 112 may be equal to a second separation distance T₂ between the second protrusion portion 112 and the third protrusion portion 113.

In another embodiment, for example, the plurality of gap spacers 150 may be provided on the first electrode portion 110 in a protruding shape along the one plane (YZ plane) perpendicular to the one direction (X direction). According to an embodiment, where the plurality of protrusion portions 111 to 114 and the second electrode portion 120 are arranged to be spaced apart from each other by a first distance W₁ along the one plane (YZ plane) perpendicular to the one direction (X direction), the second electrode portion 120 and the plurality of gap spacers 150 may be arranged to be spaced apart from each other by a second distance W₂ that exceeds (or is greater than) the first distance W along the one plane (YZ plane) (or in a direction) perpendicular to the one direction (X direction).

In an embodiment, for example, the plurality of gap spacers 150 may be formed to protrude from the outer peripheral surface of the first electrode portion 110, or may be provided in a ring shape with a hollow space and arranged to be inserted into the first electrode portion 110. According to an embodiment, the first electrode portion 110 and the plurality of gap spacers 150 may include a same material as each other and may also be integrally formed with each other as a single unitary indivisible part. However, the disclosure is not limited thereto, and the first electrode portion 110 and the plurality of gap spacers 150 may also include different materials from each other and may be formed in a way of being prepared separately and then coupled to each other.

In such an embodiment, as described above, as the separation distance between the plurality of protrusion portions 111 to 114 and the separation distance between the plurality of protrusion portions 111 to 114 and the second electrode portion 120 are accurately fixed by the plurality of gap spacers 150, uniform plasma may be generated throughout the entire discharge area E provided between the plurality of protrusion portions 111 to 114 and the second electrode portion 120. In such an embodiment, as the separation distance between the plurality of protrusion portions 111 to 114 and the separation distance between the plurality of protrusion portions 111 to 114 and the second electrode portion 120 are accurately fixed by the plurality of gap spacers 150, reproducibility of implementing the same discharge plasma in the same process may be secured.

FIG. 8A is a schematic diagram of a plasma reactor arranged with a ceramic catalyst filter, according to an embodiment. FIG. 8B is a front view of a plasma reactor arranged with a ceramic catalyst filter, according to an embodiment. FIG. 8C is a partially enlarged view of a portion of a catalyst filter as a region N illustrated in FIG. 8B.

Referring to FIGS. 8A to 8C, the plasma reactor 10 according to an embodiment may further include a ceramic catalyst filter 200 arranged within the discharge area E where plasma may be generated. In an embodiment, for example, where the ceramic catalyst filter 200 is arranged within the discharge area E, the ceramic catalyst filter 200 may be arranged between the first electrode portion 110 and the reactor 100. According to an embodiment, the ceramic catalyst filter 200 may be provided in one or plurality. In an embodiment where the ceramic catalyst filter 200 is provided in plurality, the plurality of ceramic catalyst filters 200 may be arranged to be spaced apart from each other by a certain distance in one direction (X direction).

According to an embodiment, the reactor 100 may have a cross-section of one or more of a circular or polygonal shape along one plane (YZ) plane perpendicular to the one direction (X direction). In such an embodiment, the ceramic catalyst filter 200 may have a cross-sectional shape corresponding to the cross-sectional shape of the reactor 100. In an embodiment, for example, as shown in FIG. 8B, where the reactor 100 has a circular cross-sectional shape along the one plane (YZ plane) perpendicular to the one direction (X direction), the ceramic catalyst filter 200 may also have a circular cross-sectional shape corresponding to that of the reactor 100.

The ceramic catalyst filter 200 according to an embodiment may include a ceramic support 210 and a catalyst coating layer 220 coated on the ceramic support 210. The ceramic support 210 may be a support member configured to support the catalyst coating layer 220. The ceramic support 210 according to an embodiment may include a porous honeycomb structure with a plurality of through holes 211 extending in the one direction (X direction) so that the polluted air Aᵢₙ may pass therethrough. The plurality of through holes 211 according to an embodiment may include various cross-sectional shapes, such as a circular shape, an oval shape, a polygonal shape, or the like.

In an embodiment, for example, the ceramic support 210 may include about 50 % or greater of magnesium oxide, silicon oxide, and aluminum oxide components. In addition, the ceramic support 210 according to an embodiment may further include alkaline oxide components. Examples of the alkaline oxide components may include Li₂O, Na₂O, K₂O, or the like. The ceramic support 210 that further includes the alkaline oxide components may maintain the shape of the ceramic catalyst filter without thermal deformation even at high temperature.

The catalyst coating layer 220 according to an embodiment may be coated on the ceramic support 210. In an embodiment, for example, the catalyst coating layer 220 may be directly grown on the ceramic support 210 by a one-pot reaction. However, the disclosure is not limited thereto, and the catalyst coating layer 220 may also be formed in a separate space and then be arranged to be coated on the ceramic support 210.

According to an embodiment, as the ceramic catalyst filter 200 is arranged within the discharge area E, energy supplied to the ceramic catalyst filter 200 may be ion energy. In such an embodiment, the catalyst coating layer 220 coated on the ceramic support 210 may include a metal compound capable of ozone oxidation. In an embodiment, for example, the catalyst coating layer 220 may include at least one selected from CuO, Cu₂O, MnO₂, or ZnO₂.

According to an embodiment, the catalyst coating layer 220 may have a nanostructure. In an embodiment, for example, the nanostructure included in the catalyst coating layer 220 may have at least one selected from a grain structure, a needle structure, a pillar structure, a wire structure, or a combination thereof.

According to an embodiment, when the catalyst coating layer 220 includes a nanostructure, the catalyst coating layer 220 may be provided with nano-pores formed by the nanostructure. In such an embodiment, as the catalyst coating layer 220 is provided with the nano-pores, a reaction catalytic effect may be improved. In an embodiment, for example, where the ceramic catalyst filter 200 is arranged within the discharge area E, an electric field may be increased by the nanostructure included in the catalyst coating layer 220. In addition, as micro-discharge is additionally generated in the nano-pores included in the catalyst coating layer 220, a synergy effect may occur between dielectric barrier discharge (DBD) plasma and the catalyst coating layer 220.

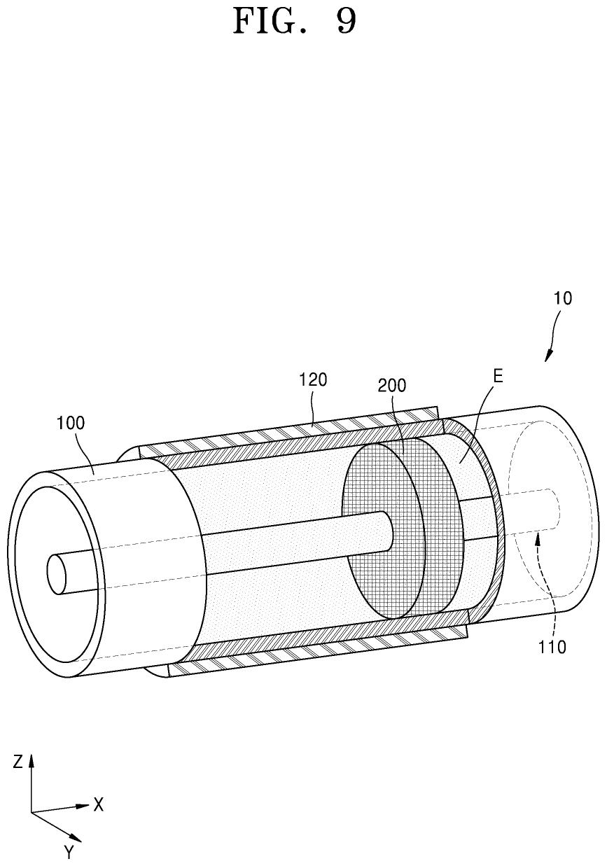

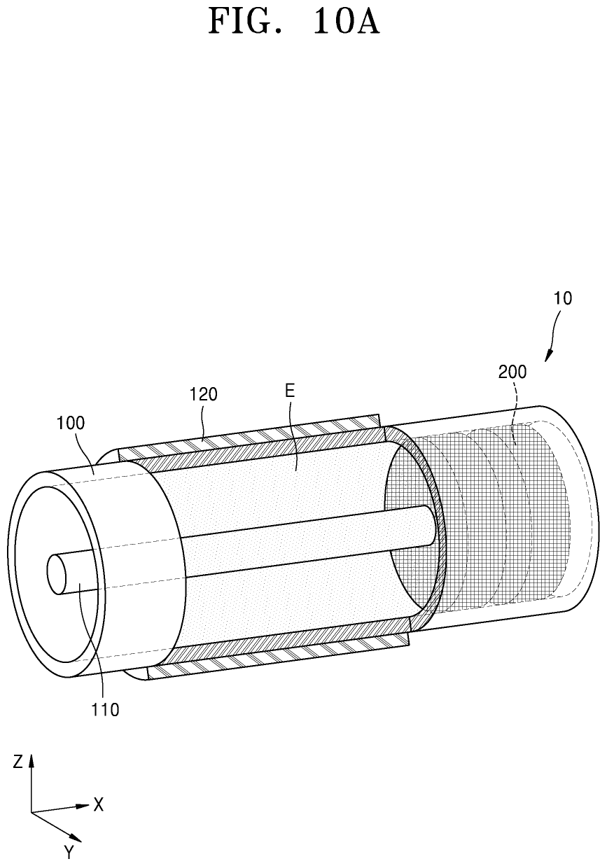

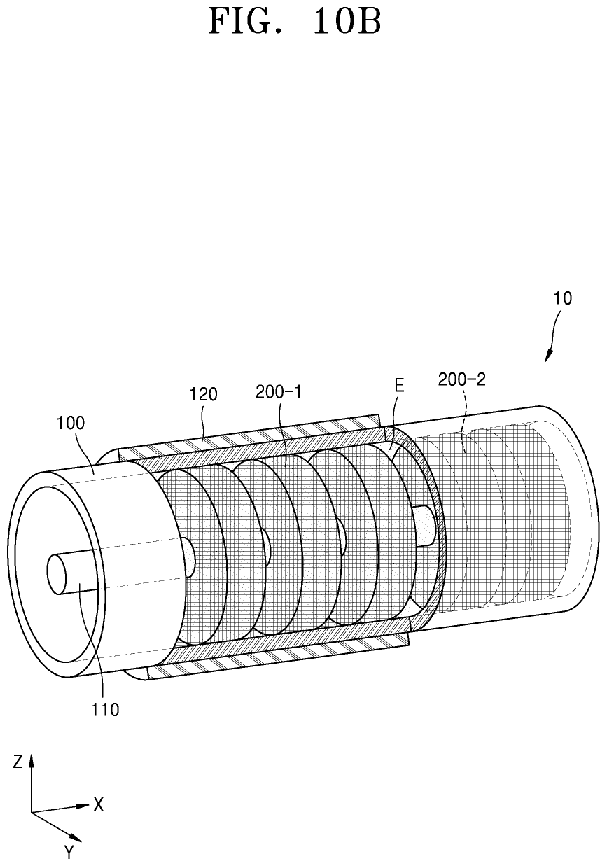

FIG. 9 is a schematic diagram of a dielectric barrier discharge plasma reactor according to an embodiment. FIG. 10A is a schematic diagram of a dielectric barrier discharge plasma reactor according to an embodiment. FIG. 10B is a schematic diagram of a dielectric barrier discharge plasma reactor according to an embodiment.

The ceramic catalyst filter 200 according to an embodiment may be arranged at various positions within the discharge area E, for example, in an in-plasma catalyst (IPC) manner. In an embodiment, for example, as shown in FIG. 8A, the ceramic catalyst filter 200 may be provided in plurality to be arranged within the discharge area E to be spaced apart from each other by a certain distance in the one direction (X direction). In another embodiment, for example, as shown in FIG. 9, the ceramic catalyst filter 200 may be arranged at a rear end portion of the discharge area E in the one direction (X direction).

The ceramic catalyst filter 200 according to an embodiment may be arranged at a position outside the discharge area E, for example, in a post-plasma catalyst (PPC) manner. In an embodiment, for example, as shown in FIG. 10A, the ceramic catalyst filter 200 may be arranged to be spaced apart from the discharge area E by a certain distance in the one direction (X direction).

The ceramic catalyst filter 200 according to an embodiment may be provided in plurality, some of the ceramic catalyst filters 200 may be arranged at various positions within the discharge area E, for example, in the IPC manner, and the remaining ceramic catalyst filters 200 may be arranged at positions outside the discharge area E, for example, in a PPC manner. In an embodiment, for example, as shown in FIG. 10B, some (at least one) ceramic catalyst filters 200-1 among the plurality of ceramic catalyst filters 200 may be arranged within the discharge area E in the one direction (X direction), and the remaining ceramic catalyst filters 200-2 among the plurality of ceramic catalyst filters 200 may be arranged to be spaced apart from the discharge area E by a certain distance in the one direction (X direction).

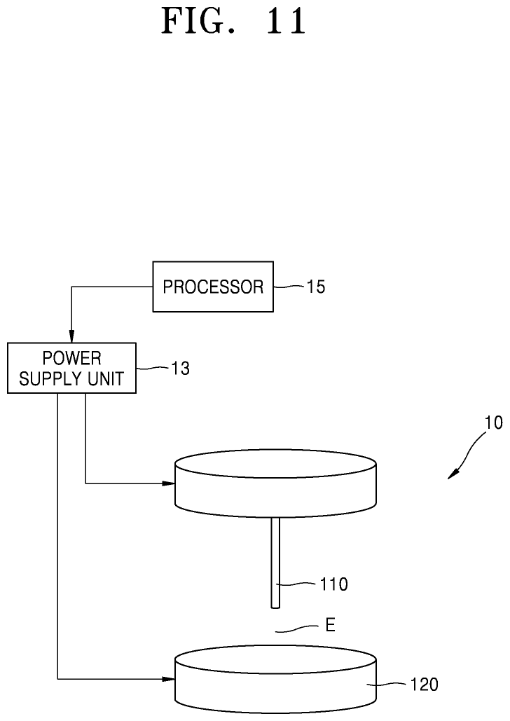

FIG. 11 is a schematic diagram of a corona discharge plasma reactor according to an embodiment.

As described above, an embodiment of the plasma reactor 10 to which pulsed power is applied may operate using a dielectric barrier discharge method as well as a corona discharge method.

Referring to FIG. 11, the plasma reactor 10 according to an embodiment may include the first electrode portion 110 having a rod shape extending in one direction, the second electrode portion 120 arranged to face the first electrode portion 110, the power supply unit 13 that applies a certain voltage to the first electrode portion 110 and the second electrode portion 120, and the processor 15. In such an embodiment, the power supply unit 13 and the processor 15 are the same as those described above with reference to FIGS. 1 to 3A, and thus any repetitive detailed description thereof will be omitted.

The first electrode portion 110 may have a rod shape extending in the one direction. In addition, the second electrode portion 120 may have a plate shape extending along one plane. According to an embodiment, the first electrode portion 110 and the second electrode portion 120 may receive pulsed power having a certain voltage from the power supply unit 13. At this time, the pulse width of the pulsed power may be about 1 ns or greater and about 160 ns or less, and the voltage thereof may be 50 about kV or less.

As the first electrode portion 110 and the second electrode portion 120 receive pulsed power having a certain voltage from the power supply unit 13, the discharge area E may be formed between the first electrode portion 110 and the second electrode portion 120. Polluted air Aᵢₙ introduced from the gas inlet 11 may pass through the discharge area E, and in this process, pollutants included in the polluted air Aᵢₙ may be decomposed and discharged as purified air Aₒᵤₜ.

FIG. 12A is a perspective view of a plurality of reactors according to an embodiment. FIG. 12B is a cross-sectional view of a plurality of plasma reactors according to an embodiment. FIG. 12C is a front view of a plasma reactor arranged with a ceramic catalyst filter, according to an embodiment.

Referring to FIGS. 12A and 12B, the plasma reactor 10 according to an embodiment may be provided in plurality. In an embodiment, for example, the plurality of plasma reactors 10 may include five plasma reactors as shown in FIGS. 12A and 12B. In such an embodiment, for example, the plurality of plasma reactors 10 may include a first plasma reactor 10-1 to a fifth plasma reactor 10-5. However, the disclosure is not limited thereto, and the number of plasma reactors may be adjusted to any number of 2 or greater. Each of the plurality of plasma reactors 10 according to an embodiment may include the reactor 100. In an embodiment, for example, the first plasma reactor 10-1 to the fifth plasma reactor 10-5 may include a first reactor 101 to a fifth reactor 105, respectively.

The first reactor 101 to the fifth reactor 105 according to an embodiment may each include a cross-section of a circular or polygonal shape. In an embodiment, for example, the first reactor 101 to the fifth reactor 105 may each be provided in a tube shape including a hexagonal cross-section. In such an embodiment, as each of the first reactor 101 to the fifth reactor 105 includes a hexagonal cross-section, the first reactor 101 to the fifth reactor 105 may be stacked adjacent to each other. Accordingly, the cross-sectional area of the reactor 100 through which the polluted air Aᵢₙ passes may be increased to the total cross-sectional areas of the first reactor 101 to the fifth reactor 105. Therefore, the treatment capacity of treating the polluted air Aᵢₙ may be increased. In addition, the first reactor 101 to the fifth reactor 105 are stacked adjacent to each other, and thus a space occupied by the air purifier 1 may be reduced.

Referring to FIG. 12C, when the reactor 100 according to an embodiment has various cross-sectional shapes along the one plane (YZ plane) perpendicular to the one direction (X direction), the ceramic catalyst filter 200 may also have a shape corresponding to that of the reactor 100. In an embodiment, for example, where the reactor 100 has a hexagonal cross-sectional shape along the one plane (YZ plane) perpendicular to the one direction (X direction), the ceramic catalyst filter 200 may have a hexagonal cross-sectional shape corresponding to the cross-sectional shape of the reactor 100.

FIG. 13A is a perspective view of a plurality of reactors according to an embodiment. FIG. 13B is a cross-sectional view of a plurality of plasma reactors according to an embodiment. FIG. 13C is a front view of a plasma reactor arranged with a ceramic catalyst filter, according to an embodiment.

Referring to FIGS. 13A and 13B, the plasma reactor 10 according to an embodiment may be provided in plurality. In an embodiment, for example, the plurality of plasma reactors 10 may include four plasma reactors as shown in FIGS. 13A and 13B. In such an embodiment, for example, the plurality of plasma reactors 10 may include a first plasma reactor 10-1 to a fourth plasma reactor 10-4. Each of the plurality of plasma reactors 10 according to an embodiment may include the reactor 100. In an embodiment, for example, the first plasma reactor 10-1 to the fourth plasma reactor 10-4 may include a first reactor 101 to a fourth reactor 104, respectively.

The first reactor 101 to the fourth reactor 104 according to an embodiment may each include a cross-section of a circular or polygonal shape. In an embodiment, for example, the first reactor 101 to the fourth reactor 104 may each be provided in a tube shape including an octagonal cross-section. As each of the first reactor 101 to the fourth reactor 104 includes an octagonal cross-section, the first reactor 101 to the fourth reactor 104 may be stacked adjacent to each other.

In an embodiment, for example, a certain separation space may be formed between the first reactor 101 to the fourth reactor 104. A cooling path 340 may be formed in the certain separation space formed between the first reactor 101 to the fourth reactor 104. The cooling path 340 may extend in one direction in which the first reactor 101 to the fourth reactor 104 extend. A certain amount of cooling water 350 may flow along the cooling path 340. As the cooling water 350 according to an embodiment, any fluid substance capable of absorbing heat generated in the first reactor 101 to the fourth reactor 104, for example, water or the like, may be used. In such an embodiment, as the cooling path 340 is arranged between the first to fourth reactors 101 to 104, and the cooling water 350 flows along the cooling path 340, heat generated in the process of forming discharge plasma may be released to the outside. Accordingly, the treatment efficiency of the air purifier 1 may be increased.

Referring to FIG. 13C, when the reactor 100 according to an embodiment has various cross-sectional shapes along the one plane (YZ plane) perpendicular to the one direction (X direction), the ceramic catalyst filter 200 may also have a shape corresponding to that of the reactor 100. In an embodiment, for example, where the reactor 100 has an octagonal cross-sectional shape along the one plane (YZ plane) perpendicular to the one direction (X direction), the ceramic catalyst filter 200 may have an octagonal cross-sectional shape corresponding to the cross-sectional shape of the reactor 100.

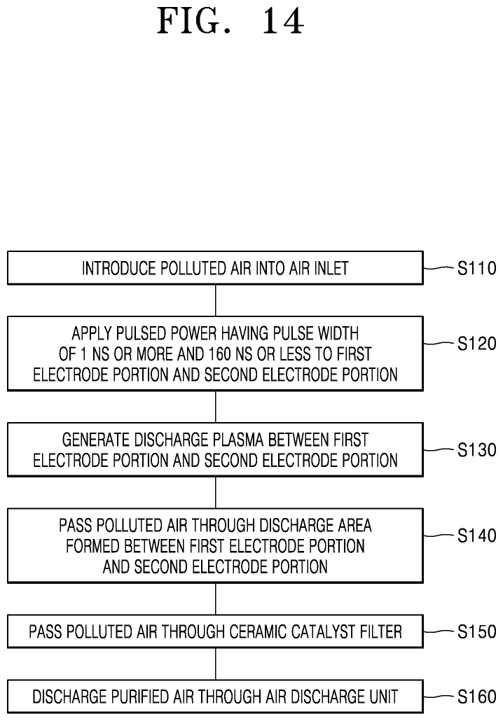

FIG. 14 is a flowchart illustrating an operating method of an air purifier according to an embodiment.

Referring to FIGS. 1 and 14, according to an embodiment of an operating method of an air purifier, polluted air Aᵢₙ may be introduced through the gas inlet 11 (S110).

Next, pulsed power having a pulse width of about 1 ns or greater and about 160 ns or less may be applied to the first electrode portion 110 and the second electrode portion 120 (S120). The processor 15 may control the power supply unit 13 to apply pulsed power having a pulse width of about 1 ns or greater and about 160 ns or less to the first electrode portion 110 and the second electrode portion 120. At this time, a voltage applied to the first electrode portion 110 and the second electrode portion 120 may be about 50 kV or less.

Then, discharge plasma may be generated between the first electrode portion 110 and the second electrode portion 120 (S130). As pulsed power is applied to the first electrode portion 110 and the second electrode portion 120, the discharge area E may be formed between the first electrode portion 110 and the second electrode portion 120.

Next, the polluted air Aᵢₙ may pass through the discharge area E between the first electrode portion 110 and the second electrode portion 120 (S140). In the process in which the polluted air Aᵢₙ passes through the discharge area E, pollutants included in the polluted air Aᵢₙ may be decomposed.

Then, the polluted air Aᵢₙ may pass through the ceramic catalyst filter 200 (S150). In the process in which the polluted air Aᵢₙ passes through the ceramic catalyst filter 200, pollutants included in the polluted air Aᵢₙ may be absorbed or decomposed by the ceramic catalyst filter 200. Accordingly, the polluted air Aᵢₙ may be purified into purified air Aₒᵤₜ.

Next, the purified air Aₒᵤₜ may be discharged to the outside through the gas discharge unit 12 (S160). The purified air Aₒᵤₜ that has passed through the plasma reactor 10 may be discharged to the outside through the gas discharge unit 12.

According to embodiments of the air purifier and the operating method of the air purifier described above, in a plasma reactor to which pulsed power is applied, the efficiency of removing pollutants may be improved by adjusting the pulse width of the pulsed power.

In addition, when a plasma-catalyst composite system arranged with a ceramic catalyst filter is implemented in a plasma reactor, an electric field may be increased by a catalytic, and a greater amount of micro-discharges may be generated in internal nano-pores, thereby enhancing a synergy effect between the generated plasma and the catalyst in the plasma reactor.

Accordingly, an air purifier with high efficiency in which removal efficiency of pollutants is improved and an operating method of the air purifier may be implemented.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An air purifier comprising:
a gas inlet into which polluted air is introduced;
a plasma reactor connected in fluid communication with the gas inlet, and having a predetermined discharge area which generates discharge plasma between a first electrode portion and a second electrode portion therein;
a power supply unit which applies, between the first electrode portion and the second electrode portion, pulsed power to generate a certain voltage; and
a processor which controls the power supply unit in a way such that the pulsed power has a pulse width of about 1 ns or greater and about 160 ns or less.

2. The air purifier of claim 1, wherein the processor controls the power supply unit in a way such that a voltage of about 50 kV or less is applied between the first electrode portion and the second electrode portion.

3. The air purifier of claim 1, wherein the plasma reactor comprises a reactor comprising a dielectric material and having a hollow shape extending in one direction,
the first electrode portion is arranged inside the reactor, and
the second electrode portion is arranged to be spaced apart from the first electrode portion by a certain distance.

4. The air purifier of claim 3, wherein the reactor has a cross-section of a circular or polygonal shape along one plane perpendicular to the one direction,
the first electrode portion comprises a high-voltage electrode to which a predetermined voltage is applied, and
the second electrode portion comprises a ground electrode.

5. The air purifier of claim 4, wherein the plasma reactor is provided in plurality,
a plurality of plasma reactors comprises a plurality of reactors, respectively, and
the plurality of reactors are stacked adjacent to each other.

6. The air purifier of claim 5, wherein
a cooling path is defined between the plurality of reactors of the plurality of plasma reactors, and
cooling water flows along the cooling path.

7. The air purifier of claim 3, wherein the plasma reactor further comprises plurality of gap spacers arranged on the first electrode portion to be spaced apart from each other by a certain distance in the one direction,
the first electrode portion is divided into a plurality of first electrode portions by the plurality of gap spacers, and
each of the plurality of gap spacers has a recessed groove shape on the first electrode portion along a plane perpendicular to the one direction.

8. The air purifier of claim 7, wherein the first electrode portion and the second electrode portion are arranged to be spaced apart from each other by a first distance along the plane perpendicular to the one direction, and
the second electrode portion and the plurality of gap spacers are arranged to be spaced apart from each other by a second distance greater than the first distance along the plane perpendicular to the one direction.

9. The air purifier of claim 3, wherein the plasma reactor further comprises plurality of gap spacers arranged on the first electrode portion to be spaced apart from each other by a certain distance in the one direction,
the first electrode portion is divided into a plurality of first electrode portions by the plurality of gap spacers,
the first electrode portion further comprises a plurality of protrusion portions protruding from the first electrode portion along the plane perpendicular to the one direction,
the plurality of gap spacers are alternately arranged with the plurality of protrusion portions on the first electrode portion in the one direction, and
each of the plurality of gap spacers has a protruding shape on the first electrode portion along the plane perpendicular to the one direction.

10. The air purifier of claim 9, wherein the plurality of protrusion portions and the second electrode portion are arranged to be spaced apart from each other by a first distance along the plane perpendicular to the one direction, and
the second electrode portion and the plurality of gap spacers are arranged to be spaced apart from each other by a second distance greater than the first distance along the plane perpendicular to the one direction.

11. The air purifier of claim 3, wherein the plasma reactor further comprises ceramic catalyst filter arranged between the reactor and the first electrode portion,
the ceramic catalyst filter comprises:
a ceramic support; and
a catalyst coating layer coated on the ceramic support, and
wherein the ceramic support has a porous honeycomb structure.

12. The air purifier of claim 11, wherein the reactor has a cross-section of a circular or polygonal shape along a plane perpendicular to the one direction, and
the ceramic catalyst filter has a cross-sectional shape corresponding to a cross-sectional shape of the reactor in the discharge area.

13. The air purifier of claim 11, wherein the ceramic catalyst filter is arranged at a rear end portion of the discharge area in the one direction.

14. The air purifier of claim 11, wherein the ceramic catalyst filter is arranged to be spaced apart from the discharge area by a certain distance in the one direction.

15. The air purifier of claim 11, wherein the ceramic catalyst filter is provided in plurality, and
the plurality of ceramic catalyst filters are arranged in the discharge area to be spaced apart from each other by a certain distance in the one direction.

16. The air purifier of claim 11, wherein the ceramic catalyst filter is provided in plurality,
at least one of the plurality of ceramic catalyst filters are arranged in the discharge area to be spaced apart from each other by a certain distance in the one direction, and
remaining ceramic catalyst filters among the plurality of ceramic catalyst filters are arranged to be spaced apart from the discharge area by a certain distance in the one direction.

17. The air purifier of claim 1, wherein the second electrode portion has a plate shape extending along one plane, and
the first electrode portion extends in one direction, and is arranged in a way such that one end portion of the first electrode portion faces the second electrode portion.

18. An operating method of the air purifier of claim 1, the operating method comprising:
introducing polluted air through the gas inlet;
applying pulsed power having a pulse width of about 1 ns or greater and about 160 ns or less to the first electrode portion and the second electrode portion;
generating discharge plasma between the first electrode portion and the second electrode portion;
passing the polluted air through the discharge area formed between the first electrode portion and the second electrode portion; and
discharging purified air through a gas discharge unit of the air purifier.

19. The operating method of claim 18, wherein a voltage applied to the first electrode portion and the second electrode portion is about 50 kV or less.

20. The operating method of claim 18, further comprising passing the polluted air through a ceramic catalyst filter arranged between a reactor of the plasma reactor and the first electrode portion.
